(19) United States
(12) Patent Application Publication
(10) Pub. No.: US 2008/0235322 A1
(43) Pub. Date: Sep. 25, 2008

(54) Media Sharing

(76) Inventors: Jan Holm, Orbyhus (SE); Henrik Albertsson, Stockholm (SE); Hubert Przybysz, Hagersten (SE)

Correspondence Address: ERICSSON INC., 6300 LEGACY DRIVE, M/S EVR 1-C-11, PLANO, TX, 75024, US

(21) Appl. No.: 12/091,388

(22) PCT Filed: Oct. 28, 2005
(86) PCT No.: PCT/EP05/55628

§ 371 Date: Apr. 24, 2008

(51) Int. Cl. G06F 15/16

(52) U.S. Cl. 709/201

(57) ABSTRACT

A method and device for distributing media from a network based content server to two or more clients participating in a burst-based service session. The method includes, following establishment of the burst-based service session, joining the content server to the session as a further participating client, sending a media grant to the content server, and delivering the requested media from the content server to the other participating clients.

### FIELD OF THE INVENTION

The present invention relates to a method and apparatus for sharing media in a push-to-talk type session.

### BACKGROUND TO THE INVENTION

Walkie-talkie type services have long proved popular amongst users who wish to communicate brief messages quickly between one another. Conventionally, such services have been provided by two-way portable radios which utilise a dedicated part of the radio spectrum, but which only allow users to communicate with a small group of pre-selected users who utilise similar terminals and who are within range of the relatively short operating range of the radios. More recently, services have been introduced into the United States which piggy-back on the existing cellular telephone infrastructure. However, these services have been proprietary in nature and have not allowed users to communicate between different operator networks.

In an attempt to broaden the use of walkie-talkie type services, an industry grouping known as the Open Mobile Alliance (www.openmobilealliance.org) has been established with the aim of standardising suitable protocols which will allow inter-network operability for Warlike-Talkie services offered over cellular networks. The service established by the various standards is known as Push to talk Over cellular (PoC). PoC makes use of the IP Multimedia Subsystem (IMS) to handle the setting up and control of PoC sessions via PoC servers (acting as SIP ASs). PoC proposes that associated speech data will be transported over a packet switched access network. In the case of GSM and UMTS, this will be the general packet radio service (GPRS) access network. In other network architectures, analogous packet switched access networks will be utilised for transporting talk data. Push to Talk services may also be offered over circuit switched access networks, although this is not the preferred option. The current state of PoC is set out in Release 1.0.

The requirements for PoC Release 2 are now being laid out. These include a requirement for sharing media content between PoC Users in a PoC Session, i.e. a push-to-watch type service. The media can be stored on the user equipment (the “PoC Client”) or on a content server in the network.

### SUMMARY OF THE INVENTION

The present invention relates to push-to-talk type services such as for example Push to talk Over cellular (PoC), as well as to related and enhanced services which are also burst based services. The term “burst-based” service is used here as a generic name for these services.

According to a first aspect of the present invention there is provided a method of distributing media from a network based content server to two or more clients participating in a burst-based service session, the method comprising:
following establishment of said session, joining the content server to the session as a further participating client;
sending a media grant to the content server; and
delivering the requested media from the content server to the other participating clients.

The invention is applicable in particular to distributing media from a network based content server to clients participating in a Push to talk Over cellular (PoC) session, according to PoC Release 1.0, 2.0, or future enhancements of the same protocols.

Preferably, said burst-based service session is established using the Session Initiation Protocol (SIP) signalling, and said content server is joined to the session as a further participating client by sending a SIP INVITE to the content server. The SIP INVITE may be sent from a controlling SIP Application Server as a result of that Server receiving a SIP REFER message from one of the participating clients. More preferably, the SIP REFER contains in the Refer-To header a SIP URI identifying the content server.

The media requested may be identified by a URI parameter appended to the URI of the content server. Alternatively, the media may be identified in an “escaped” header field of the SIP REFER message.

Preferably, after the distribution of media from the content server has been completed, the content server is removed from the ongoing session. Where SIP protocol is used to establish the session and add the content server as a participating client, the content server may be removed by one of the participating clients sending SIP REFER (BYE) request to the controlling server. Alternatively, the content server may remove itself by sending a SIP BYE request to the controlling server.

According to a second aspect of the present invention there is provided a client terminal which is able to participate in a burst-based service session with one or more other client terminals, the terminal comprising:
means for establishing a burst-based service session with one or more other client terminals;
means for subsequently causing an invitation to the ongoing session to be sent to a network based content server, the invite identifying media to be shared with the participating client terminals; and
means for receiving the identified media from the content server after the content server has joined the session as a participating client.

According to a third aspect of the present invention there is provided a content server for use in distributing media to two or more clients participating in an ongoing burst-based service session, the server comprising:
means for joining the content server to the ongoing session as a participating client; and
means for receiving a media grant from a controlling session server; and
means for sending the requested media for delivery to the other participating clients.

According to a fourth aspect of the present invention there is provided a method of distributing media from a network based content server to two or more clients participating in a burst-based service session controlled by a session controlling server, the method comprising:
following establishment of said session, sending an HTTP request from the session controlling server to the content server;
upon receipt of said request at the content server, identifying media identified in the HTTP request; and
delivering the identified media from the content server to the participating clients.

Preferably, said burst-based service session is established using the Session Initiation Protocol (SIP) signalling. The method comprises one of the participating clients sending to said controlling server a Media Burst request containing an HTTP URL identifying the content server. In response to receipt of this message, the session controlling server generates and sends said HTTP request. The media identified by the content server is returned to the session controlling server which distributes the media to the participating clients.

According to a fifth aspect of the present invention there is provided a session controlling server for use in controlling a burst based service session involving two or more participating clients, the server comprising:
means for establishing a session between two or more participating clients;
means for receiving from one of said clients a Media Burst request containing an HTTP URL identifying a content server at which media is stored;
means for generating and sending to said content server an HTTP request;
means for receiving media from said content server, and for delivering the media to the participating clients.

According to a sixth aspect of the present invention there is provided a user terminal for use in a burst based service session involving one or more other participating client terminals, the terminal comprising:
means for sending to a controlling server, a Media Burst request containing an HTTP URL identifying a content server at which media is stored, during an ongoing session with one or more other participating client terminals; and
means for receiving media from said content server via said controlling server.

### BRIEF DESCRIPTION OF THE DRAWINGS

FIG. 1 shows a signal flow sequence according to a first embodiment of the invention; and

FIG. 2 shows a signal flow sequence according to a second embodiment of the invention.

### DETAILED DESCRIPTION OF A PREFERRED EMBODIMENT

The following discussion presents two solutions to the problem of enabling a content server to distribute one or more media types to the participants in a Push-to-talk over Cellular (PoC) session. In order to facilitate this media sharing, three main issues must be addressed:

How does the PoC Server understand that a user wants to share media?

How does the PoC User identify the media?

How does the PoC User instruct the content server what to share in the PoC Session.

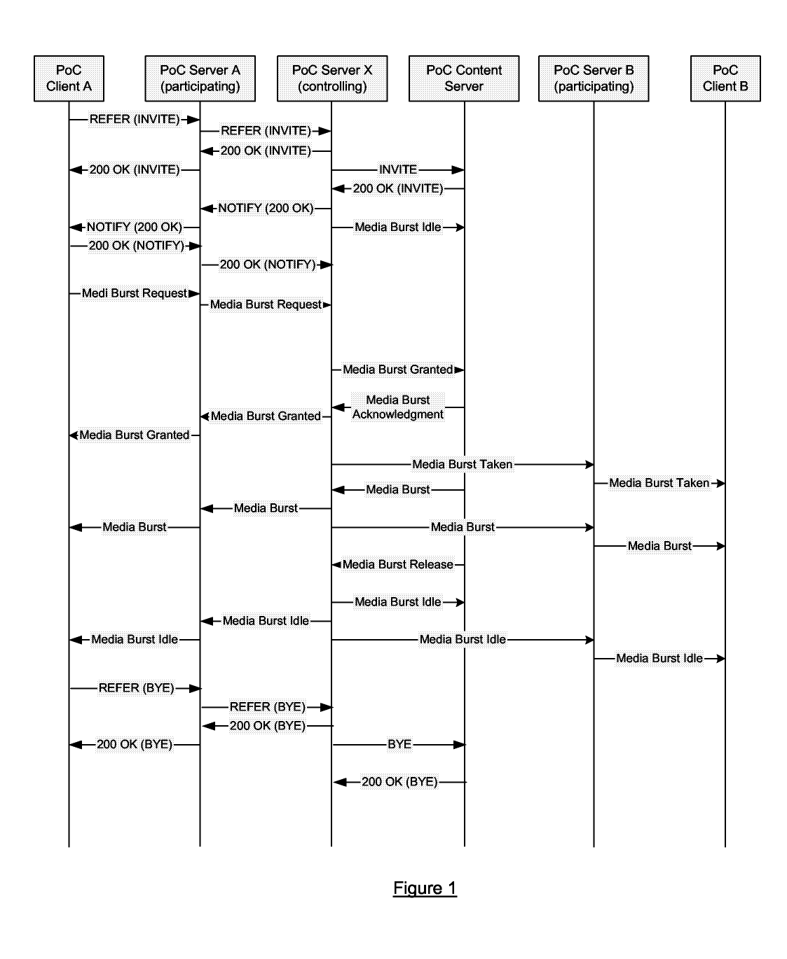

A first approach involves adding the content server as a PoC Client to the PoC Session, so that the content server is (temporarily) added to the PoC Session. To illustrate this approach, consider an ongoing PoC session between PoC Clients A and B, where each PoC Client has a participating PoC Server (PoC Servers A and B), and the session is controlled by a controlling PoC Server (PoC Server X). FIG. 1 shows the main SIP requests and SIP responses associated with this approach, where the PoC Release 1.0 names “Talk Burst Request”, “Talk Burst Idle”, etc. are changed to the generic names “Media Burst Request”, “Media Burst Idle”, etc. The message sequence is as follows:

PoC Client A sends a SIP REFER request in order to add (INVITE) the content server to the ongoing PoC Session. The SIP REFER request includes in the “Refer-To” header, the URI of the content server holding the media being requested. The media itself is also identified by a Universal Resource Indicator (URI) parameter in the address of the content server or is identified within an “escaped” header field.

PoC Server X receives the SIP REFER request and as a consequence invites the PoC Content Server as if it was an ordinary PoC User using the SIP INVITE.

The Content server accepts the invitation and sends the SIP 200 OK (INVITE) response. The PoC Server X sends a SIP NOTIFY request to the PoC Client to indicate that the Content Server has accepted.

On receipt of the SIP NOTIFY request indicating that the content server has accepted the invitation, the PoC Client A can request permission to send, for example, a picture on the behalf of the content server. This is done using the Media Burst Request message.

The PoC Server X grants the request and notifies both PoC Client A and the content server (Media Burst Granted message), as well as PoC Client B (Media Burst Taken message).

The content server sends the media to the PoC Server (Media Burst), and the PoC Server X distributes the media to all participants that are capable to receiving this type of media.

Once the media has been sent, the content server sends the Media Burst Release message and the PoC Server distributes the information (Media Burst Idle) that the floor is idle for this media type.

When the PoC Client A receives the Media Burst Idle message it can expel the content server from the PoC session by means of a SIP REFER (BYE) request. An alternative means to achieve the same result is for the content server to leave the PoC Session by means of a SIP BYE request.

The solution illustrated in FIG. 1 has the advantage that neither the PoC Client nor the PoC Servers in the network need to identify that the content server is a PoC Client.

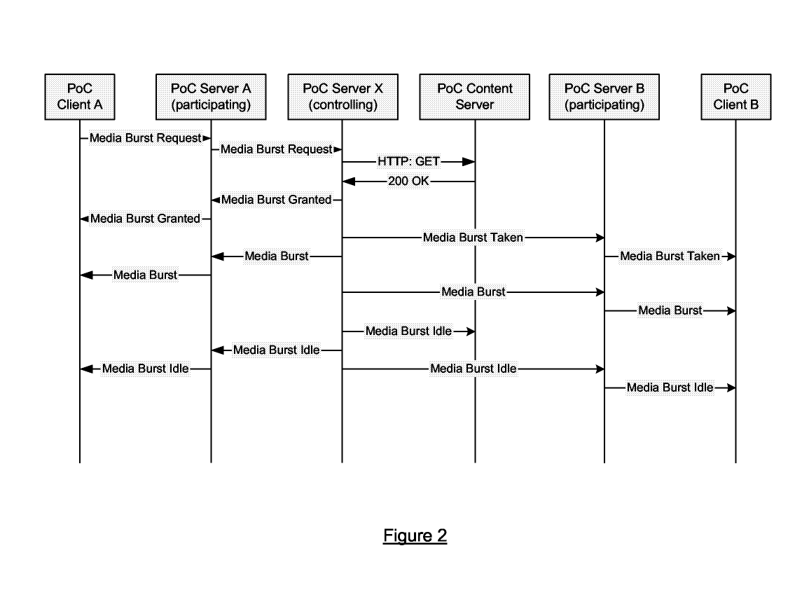

An alternative solution to the problem of enabling a content server to distribute one or more media types to the participants in a PoC session makes use of an HTTP URL instead of a SIP address to identify the media to be shared. Assume for example that a user has stored some media on a content server or is surfing a round on the Internet and finds some interesting media (e.g. a picture, an audio-clip, video-clip, etc.) that he or she wants to share. FIG. 2 shows a simplified message flow for implementing this approach. The message flow is as follows.

The PoC Client A sends a Media Burst Request message requesting permission to send media (e.g. a picture) on behalf of another user. The address of the other user is an HTTP URL, for example “http://my-content-op.net/user/˜u29502467/pictures/vacation05/kalle.jpg”.

When the PoC Server X receives the Media Burst Request message containing the HTTP address (instead of a SIP URI), it sends an HTTP GET request to the content server.

The content server returns the file identified by the HTTP GET request in the HTTP 200 “OK” response.

The PoC Server X sends a Media Burst Granted message to PoC Client A and Media Burst Taken message to the PoC Client B and starts transmitting the media (Media Burst).

Once the media has been distributed, the PoC Server X sends Media Burst Idle message to the participants (including the content server) to indicate that some one else may ask for permission to send media.

While the media sharing process is ongoing, one or other of the PoC Users can ask the controlling PoC server X for permission to send a Talk Burst during which the PoC User at PoC Client A could talk about the shared picture with the PoC User at PoC Client B. This case is not shown in the example.

The alternative solution (of FIG. 2) has the advantage that the signalling requirements are minimal. Another advantage is that this solution can be used to share media stored on any PoC “unaware” web server as long as the (controlling) PoC Server is authorized to fetch the media. On the other hand, it can only be used to share media of finite size: It is not possible to use the solution, for example, to share streaming video.

It will be appreciated by the person of skill in the art that various modifications may be made to the above described embodiments without departing from the scope of the present invention. For example, whilst the invention has been illustrated above with reference to PoC, the invention is applicable to other burst-type services such as, for example, instant messaging services.

1. A method of distributing media from a network based content server to two or more clients participating in a burst-based service session, the method comprising:
following establishment of said session, joining the content server to the session as a further participating client;
sending a media grant to the content server; and
delivering the requested media from the content server to the other participating clients.

2. The method according to claim 1, wherein said burst-based service is Push to talk Over cellular.

3. The method according to claim 1, wherein said burst-based service session is established using Session Initiation Protocol (SIP) signaling, and said content server is joined to the session as a further participating client by sending a SIP INVITE to the content server.

4. The method according to claim 3, wherein the SIP INVITE is sent from a controlling SIP Application Server as a result of the Server receiving a SIP REFER message from one of the participating clients.

5. The method according to claim 4, wherein the SIP REFER message contains in a Refer-To header, a SIP URI identifying the content server.

6. The method according to claim 5, wherein the media requested is identified by a URI parameter appended to the URI of the content server.

7. The method according to claim 5, wherein the media is identified in an escaped header field of the SIP REFER message.

8. The method according to claim 1, further comprising removing the content server from the ongoing session after the distribution of media from the content server has been completed.

9. The method according to claim 8, wherein the burst-based service session is established using SIP signaling and the content server is joined to the session as a further participating client by sending a SIP INVITE to the content server, and wherein the content server is removed by one of the participating clients sending a SIP REFER (BYE) request to the controlling server.

10. The method according to claim 8, wherein the burst-based service session is established using SIP signaling and the content server is joined to the session as a further participating client by sending a SIP INVITE to the content server, and wherein the content server is removed by the content server sending a SIP BYE request to the controlling server.

11. A client terminal for participating in a burst-based service session with one or more other client terminals, the client terminal comprising:
means for establishing a burst-based service session with one or more other client terminals;
means for subsequently causing an invitation to the ongoing session to be sent to a network based content server, the invite identifying media to be shared with the participating client terminals; and
means for receiving the identified media from the content server after the content server has joined the session as a participating client.

12. A content server for use in distributing media to two or more clients participating in an ongoing burst-based service session, the content server comprising:
means for joining the content server to the ongoing session as a participating client;
means for receiving a media grant from a controlling session server; and
means for sending the requested media for delivery to the other participating clients.

13. A method of distributing media from a network based content server to two or more clients participating in a burst-based service session controlled by a session controlling server, the method comprising:
following establishment of said session, sending an HTTP protocol request from the session controlling server to the content server;
upon receipt of said request at the content server, identifying media identified in the HTTP request; and
delivering the identified media from the content server to the participating clients.

14. The method according to claim 13, wherein said burst-based service session is established using SIP signaling.

15. The method according to claim 13, further comprising the steps of:
sending from one of the participating clients to said controlling server, a Media Burst request containing an HTTP URL identifying the content server; and
in response to receipt of the Media Burst request, generating at the session controlling server said HTTP request and sending the HTTP request to the content server.

16. The method according to claim 13, wherein said HTTP request is an HTTP GET.

17. A session controlling server for use in controlling a burst based service session involving two or more participating clients, the server comprising:
means for establishing a session between two or more participating clients;
means for receiving from one of said clients a Media Burst request containing an HTTP URL identifying a content server at which media is stored;
means for generating and sending to said content server an HTTP request,
means for receiving media from said content server, and
means for delivering the media to the participating clients.

18. A user terminal for use in a burst based service session involving one or more other participating client terminals, the user terminal comprising:
means for sending to a controlling server, during an ongoing session with one or more other participating client terminals, a Media Burst request containing an HTTP URL identifying a content server at which media is stored; and
means for receiving media from said content server via said controlling server.
